(19) United States
(12) Patent Application Publication
(10) Pub. No.: US 2017/0128783 A1
(43) Pub. Date: May 11, 2017

(54) EXERCISE PRESENTING APPARATUS, EXERCISE PRESENTING METHOD, AND EXERCISE PRESENTING PROGRAM

(71) Applicant: SEIKO EPSON CORPORATION, Tokyo (JP)

(72) Inventors: Junko HASEGAWA, Koganei-shi (JP); Jun TAKEUCHI, Matsumoto-shi (JP)

(73) Assignee: SEIKO EPSON CORPORATION, Tokyo (JP)

(21) Appl. No.: 15/129,810

(22) PCT Filed: Mar. 23, 2015
(86) PCT No.: PCT/JP2015/001632

§ 371 Date: Sep. 27, 2016

(30) Foreign Application Priority Data
Mar. 27, 2014 (JP) 2014-065070

(51) Int. Cl. A63B 24/00; G09B 19/00; G09B 5/02; A63B 71/06

(52) U.S. Cl. CPC A63B 24/0075; A63B 71/0619; G09B 19/0038; G09B 5/02; A63B 2024/0078

(57) ABSTRACT

An exercise presenting apparatus, an exercise presenting method, and an exercise presenting program present effective exercise. The exercise presenting apparatus includes a purpose acquiring section (an information acquiring section) that acquires an input purpose of exercise, an exercise setting section that sets exercise intensity and an exercise time corresponding to the acquire purpose of exercise, a presentation-information generating section that generates presentation information including at least one of the set exercise intensity and an exercise type corresponding to the exercise intensity and the exercise time, and a presenting section that presents the generated presentation information.

### TECHNICAL FIELD

The present invention relates to an exercise presenting apparatus, an exercise presenting method, and an exercise presenting program.

### BACKGROUND ART

There has been known a blood-sugar-level-data analyzing system that analyzes blood sugar level data of a diabetic or a person suspected as suffering diabetes and calculates an indicator of a saccharometabolism function (see, for example, PTL 1).

The blood-sugar-level-data analyzing system described in PTL 1 measures a blood sugar level of a subject (a patient, a medical examinee, etc.) and calculates a plurality of parameters serving as indicators of the saccharometabolism function from measurement data according to various calculation formulas. The analyzing system can determine, by referring to a determination result obtained by comparing the parameters and thresholds corresponding to the parameters, whether the subject has diabetes or is a boundary type (between a diabetes type and a normal type).

### CITATION LIST

### Patent Literature

PTL 1: Japanese Patent No. 4728616

### SUMMARY OF INVENTION

### Technical Problem

Incidentally, as therapies for life style-related diseases such as diabetes, there are known a diet therapy, an exercise therapy, and a drug therapy. Among these therapies, the exercise therapy is an extremely important therapy not only applied to diabetics alone but also extensively applied to preliminary diabetics (people determined as being the boundary type).

On the other hand, exercise is important for obesity elimination and physical strength promotion not only for the diabetics and the preliminary diabetics but also for healthy people.

Because of such a background, there has been a demand for a configuration that can present exercise corresponding to a purpose.

One of objects of the present invention is to provide an exercise presenting apparatus, an exercise presenting method, and an exercise presenting program that can present effective exercise.

### Solution to Problem

An exercise presenting apparatus according to a first aspect of the present invention includes: a purpose acquiring section that acquires an input purpose of exercise; an exercise setting section that sets exercise intensity and an exercise time corresponding to the acquire purpose; a presentation-information generating section that generates presentation information including at least one of the set exercise intensity and an exercise type corresponding to the exercise intensity and the exercise time; and a presenting section that presents the presentation information.

Note that, as the exercise presenting apparatus, a smartphone (a multifunction cellular phone), a tablet computer, and a PC (Personal Computer), and the like can be illustrated. As the presenting section, a display section that displays an image and a sound output section that outputs sound can be illustrated.

According to the first aspect, exercise intensity and an exercise time corresponding to a purpose of exercise input by a user are set by the exercise setting section. Presentation information including at least one of the exercise intensity and an exercise type corresponding to the exercise intensity and the exercise time is generated by the presentation-information generating section. The presentation information is presented by the presenting section. Consequently, it is possible to present exercise corresponding to the purpose of the exercise input by the user. Therefore, it is possible to present effective exercise corresponding to the purpose of the user. When the exercise type corresponding to the input exercise intensity is presented, the user can easily grasp exercise that the user should implement. Therefore, the user can easily implement the presented exercise.

In the first aspect, it is preferable that the exercise presenting apparatus further includes a parameter acquiring section that acquires input personal parameters of at least any one of presence or absence of exercise habits of a user, a physical condition of the user, and an intensity level of exercise preferred by the user, and the exercise setting section sets the exercise intensity and the exercise time corresponding to the purpose and the personal parameters.

According to the first aspect, the exercise setting section sets the exercise intensity and the exercise time on the basis of the personal parameters acquired by the parameter acquiring section and the purpose of the exercise of the user acquired by the purpose acquiring section. Consequently, it is possible to present exercise suitable for a situation of the user. For example, it is possible to present exercise with low exercise intensity to a user not having exercise habits, a user having a bad physical condition, and a user who desires rather weak exercise and present exercise with high exercise intensity to a user having exercise habits, a user having a good physical condition, and a user who desires rather intense exercise. Therefore, it is possible to present effective exercise to the user.

In the first aspect, it is preferable that the purpose is selected from selection items including elimination of a high blood sugar level after a meal and obesity elimination and input.

Note that exercise targeting the obesity elimination is also effective for fat burning, health promotion, physical strength improvement, and physical constitution improvement. Therefore, any one of these maybe incorporated as a selection item instead of the selection item of the obesity elimination.

Exercise intensity effective for a purpose is different between exercise for the high blood sugar elimination after a meal and exercise for the obesity elimination. Specifically, in order to achieve the high blood sugar elimination after a meal, compared with when the obesity elimination is achieved, an effect of implementing exercise with high exercise intensity is high. In this way, an appropriate exercise load is sometimes different according to a purpose of exercise.

On the other hand, in the first aspect, the purpose of the exercise is selected from the selection items including the high blood sugar elimination after a meal and the obesity elimination and input. Therefore, it is possible to retain exercise intensity corresponding to a selected purpose in advance. Consequently, it is possible to surely present exercise having exercise intensity corresponding to the selected purpose of the exercise, that is, exercise for the high blood sugar elimination after a meal and exercise for the obesity elimination. Since the user can input a purpose of exercise by selecting the purpose of the exercise from the selection items, the user can input the purpose without being confused.

In the first aspect, it is preferable that the presentation-information generating section generates the presentation information including effect information indicating an effect by implementation of exercise indicated by the set exercise intensity and the set exercise time.

In the first aspect, besides information (at least one of exercise intensity and an exercise type and an exercise time) concerning exercise that the exercise presenting apparatus causes the user to implement, an effect by implementation of the exercise is presented. Consequently, it is possible to improve motivation of the user who implements the presented exercise.

In the first aspect, it is preferable that the effect information indicates at least one of duration of the effect classified for each of types and a cumulative value of the effect in a predetermined period.

According to the first aspect, since each of a plurality of effects by implementation of exercise can be grasped, it is possible to further improve the motivation.

The effect information included in the presentation information to be presented is information indicating at least one of duration of an effect classified for each of types and a cumulative value of the effect. Consequently, it is possible to grasp what kind of effect continues how long when exercise is performed once and to which degree the effect has accumulated. Therefore, in this regard as well, it is possible to further improve the motivation.

In the first aspect, it is preferable that, after exercise indicated by the set exercise intensity and the set exercise time is implemented, the presenting section presents a residual time of duration of an effect by implementation of the exercise.

In the first aspect, a residual time of duration of an effect by implementation of presented exercise is presented by the presenting section. Consequently, as time elapses from the implementation of the exercise, the residual time of the duration of the effect decreases. If exercise is not performed, the residual time decreases to 0. Therefore, since it is possible to grasp that the effect by the implemented exercise decreases, it is possible to further improve the motivation.

An exercise presenting method according to a second aspect of the present invention is an exercise presenting method performed using an exercise presenting apparatus that presents exercise that the exercise presenting apparatus causes a user to implement. The exercise presenting method includes: a purpose acquiring step for acquiring an input purpose of exercise; an exercise setting step for setting exercise intensity and an exercise time corresponding to the acquire purpose; and an exercise presenting step for presenting presentation information including at least one of the set exercise intensity and an exercise type corresponding to the exercise intensity and the exercise time.

According to the second aspect, it is possible to achieve an effect same as the effect of the exercise presenting apparatus according to the first aspect by applying the exercise presenting method to the exercise presenting apparatus.

An exercise presenting program according to a third aspect of the present invention is an exercise presenting program executed by an exercise presenting apparatus that presents exercise that the exercise presenting apparatus causes a user to implement, the exercise presenting program causing the exercise presenting apparatus to present the exercise. The exercise presenting program causes the exercise presenting apparatus to execute: a purpose acquiring step for acquiring an input purpose of exercise; an exercise setting step for setting exercise intensity and an exercise time corresponding to the acquire purpose; and an exercise presenting step for presenting presentation information including at least one of the set exercise intensity and an exercise type corresponding to the exercise intensity and the exercise time.

According to the third aspect, the exercise presenting apparatus executes the exercise presenting program, whereby it is possible to achieve an effect same as the effect of the exercise presenting apparatus according to the first aspect.

Note that such an exercise presenting program may be recorded in a computer-readable recording medium. The exercise presenting apparatus reads the exercise presenting program from such a recording medium and executes the exercise presenting program, whereby it is possible to achieve an effect same as the effect of the exercise presenting apparatus according to the first aspect. As the recording medium, a magnetic tape, a magnetic disk, an optical disk, a magneto-optical disk, a HDD (Hard Disk Drive), a semiconductor memory, and the like can be illustrated. It is possible to execute the exercise presenting program and the information processing apparatus using these media. Besides, the exercise presenting program may be presented via a network.

### BRIEF DESCRIPTION OF THE DRAWINGS

FIG. 1 is a schematic diagram showing an exercise supporting system according to an embodiment of the present invention.

FIG. 2 is a block diagram showing the configuration of a measuring apparatus in the embodiment.

FIG. 3 is a block diagram showing the configuration of an information processing apparatus in the embodiment.

FIG. 4 is a block diagram showing the configuration of a control section in the embodiment.

FIG. 5 is a diagram showing an example of a condition setting screen in the embodiment.

FIG. 6 is a diagram showing an example of an exercise presentation screen in the embodiment.

FIG. 7 is a diagram showing an example of a result input screen in the embodiment.

FIG. 8 is a diagram showing an example of a result check screen in the embodiment.

FIG. 9 is a flowchart showing exercise presentation processing in the embodiment.

FIG. 10 is a flowchart showing result presentation processing in the embodiment.

### DESCRIPTION OF EMBODIMENTS

An embodiment of the present invention is explained below with reference to the drawings.

### [Schematic Configuration of an Exercise Supporting System]

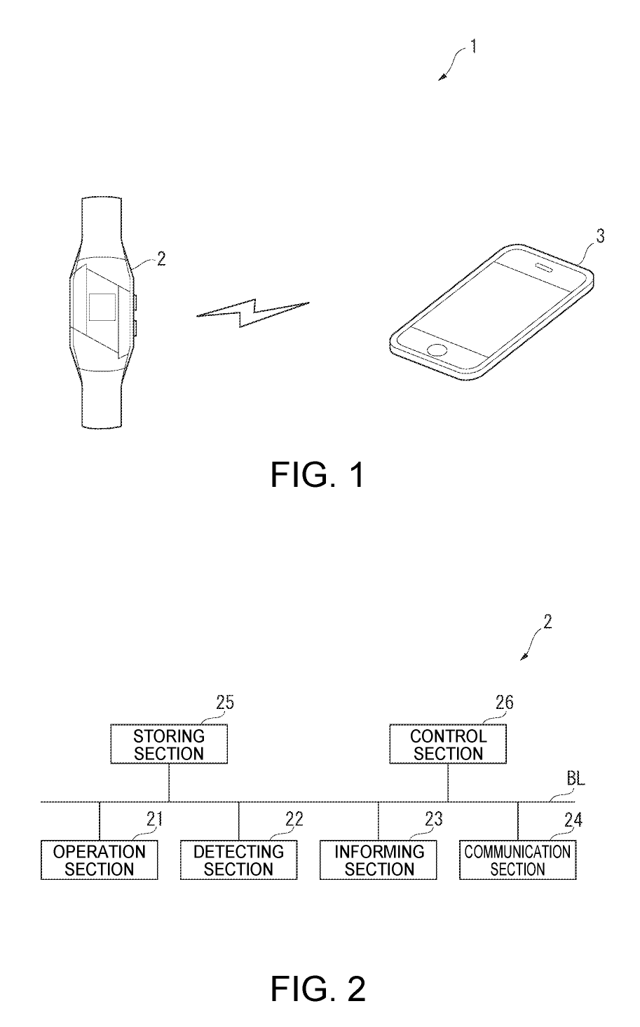

FIG. 1 is a schematic diagram showing an exercise supporting system 1 according to this embodiment.

The exercise supporting system 1 according to this embodiment includes, as shown in FIG. 1, a measuring apparatus 2 and an information processing apparatus 3. In the exercise supporting system 1, the information processing apparatus 3 presents, to a user, exercise corresponding to a purpose of exercise input by the user and various personal parameters of the user. Besides, the information processing apparatus 3 presents an exercise result on the basis of behavior information concerning behavior of the user measured by the measuring apparatus 2.

The components of the exercise supporting system 1 are explained below.

### [Configuration of the Measuring Apparatus]

FIG. 2 is a block diagram showing the configuration of the measuring apparatus 2.

The measuring apparatus 2 is a measuring apparatus worn by a user to measure biological information and motion information of the user. The measuring apparatus 2 includes, as shown in FIG. 2, an operation section 21, a detecting section 22, an informing section 23, a communication section 24, a storing section 25, and a control section 26, which are connected to one another by a bus line BL.

The operation section 21 includes a switch provided on the outside of an exterior housing of the measuring apparatus 2. The operation section 21 outputs an operation signal corresponding to an input of the switch to the control section 26.

The detecting section 22 detects biological information of the user and motion information concerning a motion of the user. In this embodiment, the detecting section 22 includes a pulse wave sensor that detects a pulse wave as the biological information and an acceleration sensor that detects, as the motion information, an acceleration value acting according to the motion of the user. The detecting section 22 outputs detection results by the sensors to the control section 26.

The informing section 23 includes a display section that displays a predetermined image and a vibrating section.

The display section displays an image corresponding to an image signal input from the control section 26. The display section can be configured by various displays.

The vibrating section includes a motor driven according to a driving signal input from the control section 26. The vibrating section generates vibration when the motor is driven.

The communication section 24 includes a communication module that communicates with an external apparatus (e.g., the information processing apparatus 3) under the control by the control section 26.

The storing section 25 has stored therein programs and data necessary for the operation of the measuring apparatus 2. Besides, the storing section 25 stores a detection result by the detecting section 22.

The control section 26 controls the operation of the entire measuring apparatus 2. For example, the control section 26 calculates a pulse rate (a pulse rate per unit time) of the user on the basis of a detection result input from the detecting section 22 and causes the storing section 25 to store the pulse rate. The control section 26 transmits the detection result by the detecting section 22 and measurement information including the measured pulse rate to the external apparatus via the communication section 24.

### [Configuration of the Information Processing Apparatus]

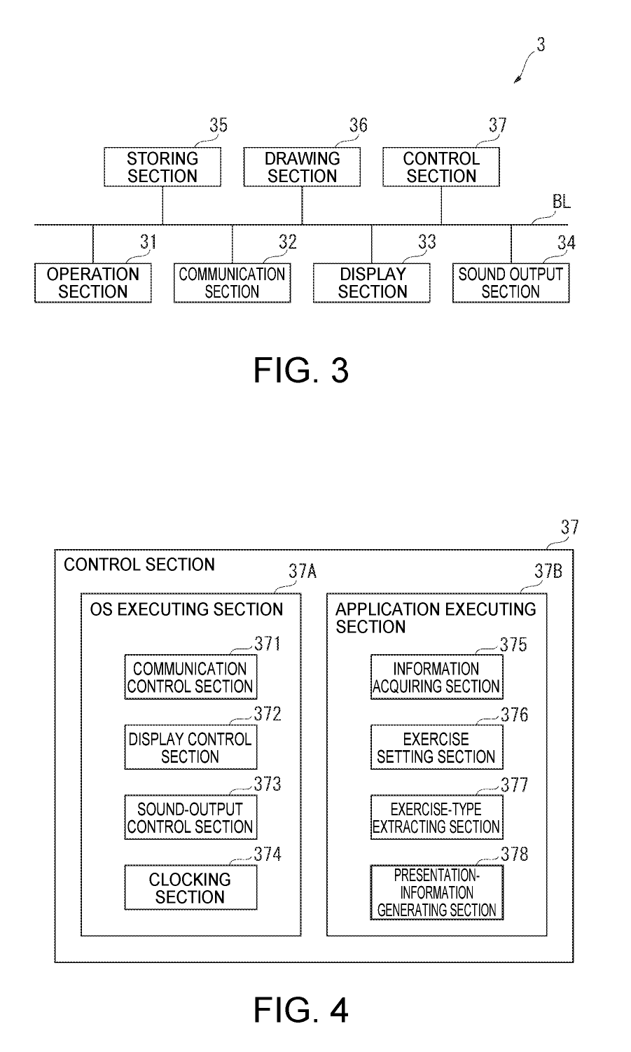

FIG. 3 is a block diagram showing the configuration of the information processing apparatus 3.

The information processing apparatus 3 stores the behavior information received from the measuring apparatus 2. The information processing apparatus 3 is equivalent to the exercise presenting apparatus of the present invention and presents exercise corresponding to, for example, a purpose of exercise input by the user. The information processing apparatus 3 can be configured by, for example, a smartphone (a multifunction cellular phone), a tablet computer, and a PC (Personal Computer).

Such an information processing apparatus 3 includes, as shown in FIG. 2, an operation section 31, a communication section 32, a display section 33, a sound output section 34, a storing section 35, a drawing section 36, and a control section 37, which are connected to one another by the bus line BL.

The operation section 31 receives input operation by the user and outputs an operation signal corresponding to the input operation to the control section 37. Such an operation section 31 can be configured by, for example, physical keys, a touch panel and the like provided on a housing of the information processing apparatus 3. Besides, the operation section 31 can be configured by a keyboard, a pointing device, and the like connected to the information processing apparatus 3.

The communication section 32 includes a communication module capable of communicating with an external apparatus such as the measuring apparatus 2 and communicates with the external apparatus under the control by the control section 37.

The display section 33 displays an image drawn by the drawing section 36. Specifically, the display section 33 displays execution screens for an OS (Operating System) and applications executed by the control section 37. That is, the display section 33 functions as a presenting section that displays an execution screen for an exercise supporting application explained below and presents exercise information and the like to the user. Such a display section 33 can be configured by, for example, various display panels such as a liquid crystal display panel, an organic EL (Elector-Luminescence) display panel, and an electrophoresis display panel.

The sound output section 34 includes a speaker and outputs sound corresponding to sound information input from the control section 37. For example, when the control section 37 executes the exercise supporting application, the sound output section 34 outputs sound corresponding to information presented to the user. That is, like the display section 33, the sound output section 34 is equivalent to the presenting section of the present invention.

The storing section 35 is configured by a HDD (Hard Disk Drive), a flash memory, and the like and stores a program and data necessary for the operation of the information processing apparatus 3. As such a program, the storing section 35 has stored therein, for example, besides the OS, the exercise supporting application (an exercise presenting program) for causing the control section 37 to execute exercise presentation processing and result presentation processing explained below.

As the data, for example, the storing section 35 stores, besides storing user information, the measurement information received from the measuring apparatus 2 and various kinds of information input on an execution screen for the exercise supporting application.

Further, the storing section 35 has stored therein a table in which a purpose of exercise input by the user, presence or absence of exercise habits, and a physical condition and preference of exercise (an intensity level of exercise desired by the user) and exercise intensity are associated. Besides, the storing section 35 has stored therein a type table in which exercise intensity and an exercise type are associated. As such an exercise type, walking, running, swimming, cycling, and the like can be illustrated.

The drawing section 36 can be configured by a drawing circuit and draws, under the control by the control section 37, an image to be displayed on the display section 33. For example, when the control section 37 is executing the exercise supporting application, the drawing section 36 draws an execution screen for the application.

### [Configuration of the Control Section]

FIG. 4 is a block diagram showing the configuration of the control section 37.

The control section 37 includes a CPU (Central Processing Unit). The CPU executes the program stored in the storing section 35, whereby the control section 37 controls the operation of the information processing apparatus 3. Such a control section 37 includes an OS executing section 37A and an application executing section 37B.

The OS executing section 37A is a functional section that executes the OS stored in the storing section 35 and includes a communication control section 371, a display control section 372, a sound-output control section 373, and a clocking section 374.

The communication control section 371 controls the communication section 32 to communicate with the external apparatus.

The display control section 372 controls the drawing section 36 to cause the drawing section 36 to draw execution screens for the OS and applications and cause the display section 33 to display the execution screens.

The sound-output control section 373 outputs, to the sound output section 34, sound information of sound output during execution of the OS and the applications.

The clocking section 374 clocks the present time.

### [Configurations of Execution Screens]

During the execution of the exercise supporting application by the application executing section 37B, the display control section 372 causes the drawing section 36 to draw, for example, execution screens ES (ES1 to ES4) explained below and causes the display section 33 to display the screens ES.

The configurations and the operations of the screens ES are explained below.

### [Configuration of a Condition Setting Screen]

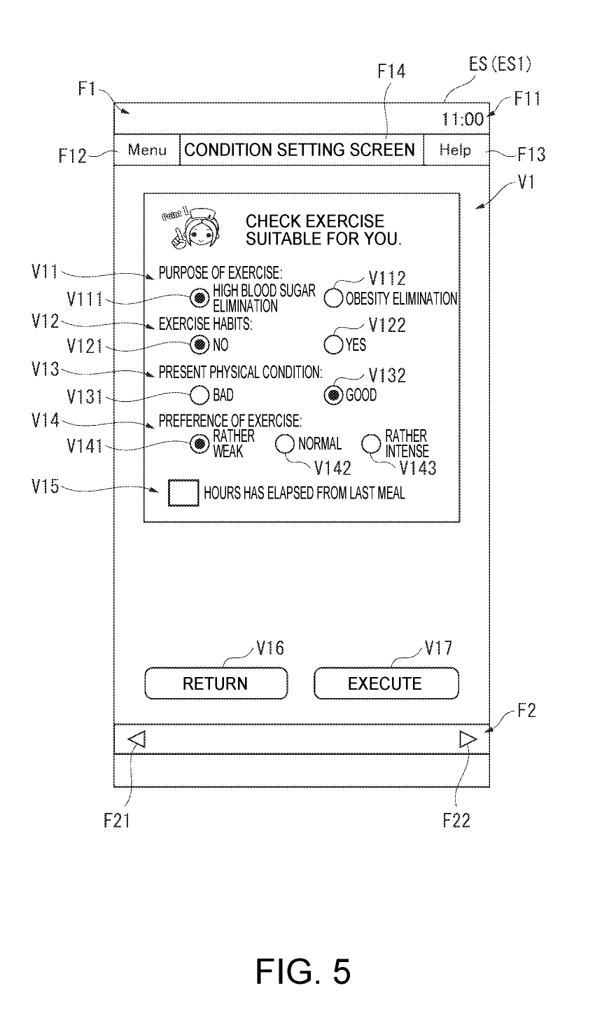

FIG. 5 is a diagram showing an example of a condition setting screen ES1 among the execution screens ES.

The condition setting screen ES1 is an input screen for causing the user to input exercise setting conditions including a purpose of exercise, a plurality of personal parameters, and an elapsed time from a most recent meal.

Such a condition setting screen ES1 includes, as shown in FIG. 5, fixed display regions F1 and F2 and a variable display region V1 sandwiched between the fixed display regions F1 and F2.

The fixed display region F1 located in an upper part of the condition setting screen ES1 includes, at an upper right corner, a time display region F11 in which the present time clocked by the clocking section 374 is set. In a part on the left side in the fixed display region F1, a button F12, which transitions to a menu screen (not shown in the figure) when depressed (input), is disposed. In a part on the right side, a button F13, which transitions to a help screen (not shown in the figure) when depressed, is disposed. In a part substantially in the center in the fixed display region F1, a title F14 of the screen is disposed.

The fixed display region F2 located in a lower part of the condition setting screen ES1 includes buttons F21 and F22 in left and right parts. The buttons F21 and F22 are buttons for transitioning the screen.

The variable display region V1 includes a purpose setting region V11, three parameter setting regions V12 to V14, and an elapsed-time setting region V15.

The purpose setting region V11 is a setting region for causing the user to set a purpose of exercise. In this embodiment, the purpose setting region V11 is a selection region. Specifically, in the purpose setting region V11, two selection items of “high blood sugar elimination” after a meal and “obesity elimination” are set as the purpose of exercise. Radio buttons V111 and V112 corresponding to the selection items are disposed. Of the radio buttons V111 and V112, the radio button corresponding to the selection item selected by the user is checked.

Note that, in this embodiment, the “high blood sugar elimination” and the “obesity elimination” are illustrated as the selection items of the purpose of exercise. However, the selection items are not limited to these selection items and may include other selection items. Instead of the selection items of the “obesity elimination”, selection items of “fat burning”, “health promotion”, “physical strength improvement”, and “physical constitution improvement” may be illustrated.

The parameter setting regions V12 to V14 are respectively regions for causing the user to set personal parameters related to the present status of the individual.

The parameter setting region V12 is exercise-habit setting region for causing the user to set presence or absence of exercise habits. In the parameter setting region V12, two selection items of “no” indicating that exercise habits are absent and “yes” indicating that exercise habits are present are set. Radio buttons V121 and V122 are disposed according to the selection items. Of the radio buttons V121 and V122, the radio button corresponding to the selection item selected by the user is checked.

The parameter setting region V13 is a physical-condition setting region for causing the user to set the present physical condition. In the parameter setting region V13, two selection items of “bad” indicating that the physical condition is bad and “good” indicating that the physical condition is good are set. Radio buttons V131 and V132 are disposed according to the selection items. As in the above explanation, of the radio buttons V131 and V132, the radio button corresponding to the selection item selected by the user is checked.

The parameter setting region V14 is an intensity-level setting region for causing the user to set preference of exercise of the user, that is, an intensity level of exercise desired by the user. In the parameter setting region V14, three selection items of “rather weak” selected when the user desires to implement rather weak exercise, “normal” selected when the user desires to implement normal exercise, and “rather intense” selected when the user desires to implement rather intense exercise are set. Radio buttons V141, V142, and V143 are disposed according to the selection items. As in the above explanation, among the radio buttons V141 to V143, the radio button corresponding to the selection item selected by the user is checked.

The elapsed-time setting region V15 is a setting region for causing the user to set an elapsed time from a most recent meal. In this embodiment, the elapsed-time setting region V15 is an input region for causing the user to input the elapsed time.

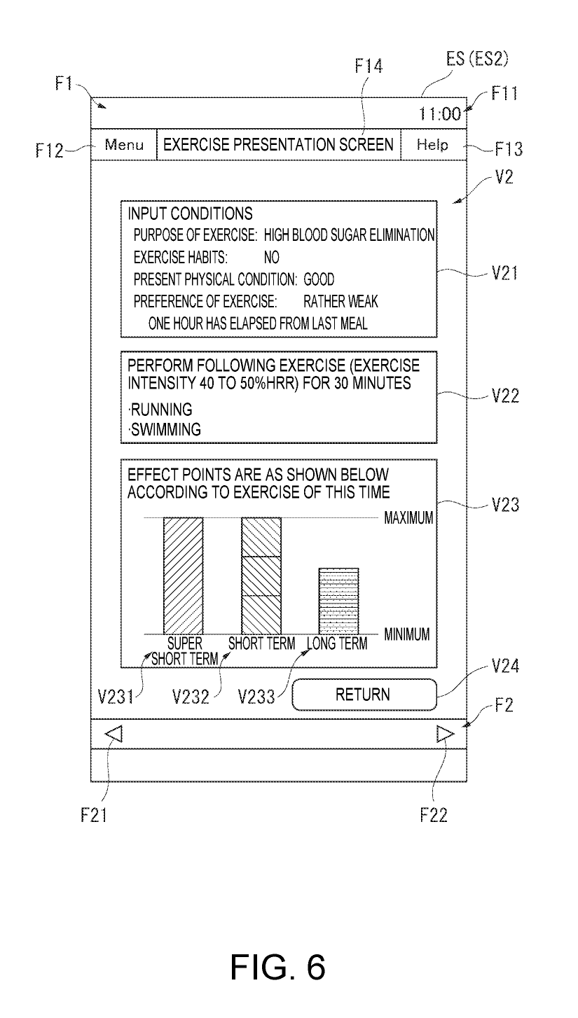

In a lower part in the variable display region V1, a button V16 inscribed as “return” and a button V17 inscribed as “execute” are disposed. Of these buttons, when the button V16 is depressed (input), the condition-setting screen ES1 returns to a screen displayed before the transition to the condition setting screen ES1. On the other hand, when the button V17 is depressed, the condition setting screen ES1 is transitioned to an exercise presentation screen ES2 (see FIG. 6) on which exercise corresponding to a purpose set by the user, individual parameters, and an elapsed time is presented.

Note that setting contents for the purpose setting region V11, the parameter setting regions V12 to V14, and the elapsed-time setting region V15 are stored in the storing section 35.

When the condition setting screen ES1 is displayed again, the purpose setting region V11 and the parameter setting regions V12 to V14 are displayed in states set according to the last setting contents. Note that it is possible to change the setting contents.

On the other hand, in this embodiment, the elapsed-time setting region V15 is a setting region for causing the user to input an elapsed time every time the condition setting screen ES1 is displayed. Therefore, even when the condition setting screen ES1 is displayed again, the elapsed-time setting region V15 is blank. However, like the setting regions V11 to V14, values corresponding to the last setting contents may be set in advance.

### [Configuration of the Exercise Presentation Screen]

FIG. 6 is a diagram showing an example of the exercise presentation screen ES2 among the execution screens ES.

When a button V17 disposed on the condition setting screen ES1 is input, the exercise presentation screen ES2 shown in FIG. 6 is displayed on the display section 33. The exercise presentation screen ES2 is a screen for presenting exercise corresponding to the exercise setting conditions set in the setting regions V11 to V15.

Like the condition setting screen ES1, the exercise presentation screen ES2 includes the fixed display regions F1 and F2 and a variable display region V2 sandwiched between the fixed display regions F1 and F2.

The variable display region V2 includes a setting-condition display region V21, an exercise presentation region V22, a predicted-effect presentation region V23, and a button V24 inscribed as “return” respectively disposed in order from an upper part in the variable display region V2.

The setting-condition display region V21 is a display region where the exercise setting conditions set by the user on the condition setting screen ES1 are displayed. For example, in the example of the exercise presentation screen ES2 shown in FIG. 6, in the setting-condition display region V21, “high blood sugar elimination” is set as the purpose of exercise, “no” is set as the exercise habits, “good” is set as the “present physical condition”, “rather weak” is set as the “preference of exercise”, and “1” is set as the elapsed time from the most recent meal.

The exercise presentation region V22 is a display region for presenting exercise intensity and an exercise time set as targets corresponding to the exercise setting conditions and an exercise type corresponding to the exercise intensity. For example, in the example of the exercise presentation screen ES2 shown in FIG. 6, a message including “exercise intensity 40 to 50% HRR” as target exercise intensity, including “running” and “swimming” as exercise types corresponding to the target exercise intensity, and including “30 minutes” as a target exercise time is set in the exercise presentation region V22 as exercise information indicating contents of exercise that the information processing apparatus 3 causes the user to implement.

HRR means a heart rate reserved and represents a difference between a resting heart rate and a maximum heart rate (substantially synonymous with a difference between a resting pulse rate and a maximum pulse rate). In this embodiment, exercise intensity is represented by exercise intensity based on the Karvonen Formula. However, the exercise intensity may be represented by exercise intensity such as METs, which is an oxygen consumption amount, and a Borg scale (subjective exercise intensity).

The predicted-effect display region V23 is a region indicating duration of an effect and a degree of accumulation of the effect at the time when presented exercise is implemented by the user. That is, the predicted-effect presentation region V23 is a region where effect information indicating effects generated by implementation of the exercise is presented. Specifically, the predicted-effect presentation region V23 is a region where effect information indicating a plurality of effects respectively having different durations among the effects is presented.

The effects by the exercise can be classified into three effects of a super short term effect, a short term effect, and a long term effect. Therefore, in this embodiment, the predicted-effect presentation region V23 includes three regions representing the respective effects for each of the types, that is, a super-short-term-effect prediction region V231, a short-term-effect prediction region V232, and a long-term-effect prediction region V233.

Examples of the super short term effect include effects such as energy supply to muscles during exercise and suppression of a blood sugar level increase by recovery of muscle glycogen after the exercise. The effect is maintained for several hours to one day after the exercise. That is, immediately after the presented exercise is implemented, since the duration of the super short term effect is the longest, a bar graph extending to a maximum is set in the super-short-term-effect prediction region V231.

Examples of the short term effect include temporary improvement of insulin resistance by exercise (i.e., development of a glucose transporter Glut4). The short term effect is maintained for approximately three days after the exercise. That is, immediately after the presented exercise is implemented, since the duration of the short term effect is the longest, a bar graph extending to a maximum is set in the short-term-effect prediction region V232. Note that the bar graph set in the short-term-effect prediction region V232 is represented as a diagram in which three (equivalent to the duration of the short-term effect) blocks having size equivalent to ⅓ of the maximum, that is, blocks equivalent to time for one day are stacked.

Examples of the long term effect include long term improvement of the insulin resistance and a visceral fat decrease. The effect appears when exercise is continuously implemented for at least thirty days. The effect is actually felt when the exercise is continuously implemented for several months. Therefore, in the long-term-effect prediction region V233, on the assumption that the presented exercise is performed, a bar graph is set in which blocks corresponding to a number obtained by adding one to the number of days of implementation of the presented exercise in thirty days in the past, that is, the number of exercise implementation days are stacked. Therefore, a maximum number of blocks configuring the bar graph is thirty equivalent to the thirty days. That is, the bar graph shown in the long-term-effect prediction region V233 indicates a cumulative value of the long term effect for thirty days, which is a predetermined period.

Since such an exercise presentation screen ES2 is displayed, the user can grasp exercise intensity, an exercise type, and an exercise time suitable for the exercise setting conditions. Besides, the user can visually grasp an effect by implementation of the presented exercise.

### [Configuration of a Result Input Screen]

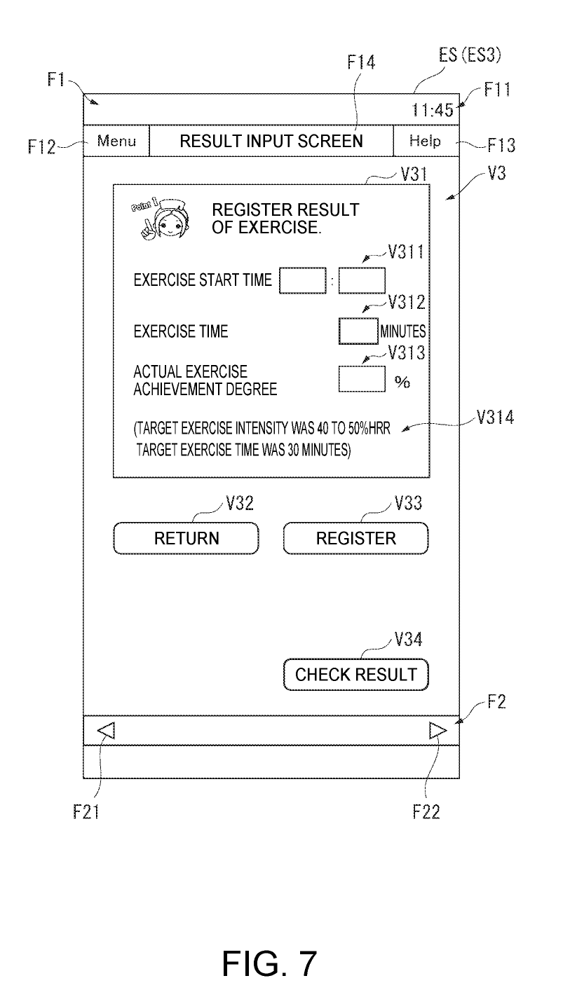

FIG. 7 is a diagram showing an example of a result input screen ES3 among the execution screens ES.

During execution of the exercise supporting application, when input operation for displaying the result input screen is performed by the user, the result input screen ES3 shown in FIG. 7 is displayed on the display section 33.

The result input screen ES3 is an input screen to which the user inputs an implementation result of presented exercise. Like the condition setting screen ES1, the result input screen ES3 includes the fixed display regions F1 and F2 and a variable display region V3 sandwiched between the fixed display regions F1 and F2.

The variable display region V3 includes a result input region V31, a button V32 inscribed as “return”, a button V33 inscribed as “register”, and a button V34 inscribed as “result check”.

Among these buttons, when the button V32 is input, the result input screen ES3 returns to a screen displayed before the transition to the result input screen ES3.

The result input region V31 includes a start-time input region V311, an exercise-time input region V312, an achievement-degree input region V313, and a target-exercise display space V314.

The start-time input region V311 and the exercise-time input region V312 are regions for the user to respectively input start time and an exercise time of exercise implemented by the user.

The achievement-degree input region V313 is a region for the user to input, according to own decision, an achievement degree of the exercise implemented by the user.

In the target-exercise display space V314, a message including exercise intensity and an exercise time presented on the basis of the latest exercise setting conditions set by the user is set.

When the button V33 is input (depressed), contents input in the result input region V31 are stored and registered in the storing section 35 in association with a date of the day. Note that it is also possible to display the result input screen ES3 again and correct an exercise result. Further, it is also possible to input and register a result of another kind of exercise.

On the other hand, when the button V34 is input, the result input screen ES3 transitions to a result check screen ES4 explained below.

Note that, when the measurement information is receivable from the measuring apparatus 2, it is possible to acquire, on the basis of the measurement information, start time, an exercise time, and exercise intensity of exercise actually implemented by the user. It is also possible to acquire an achievement degree of exercise on the basis of the start time, the exercise time, and the exercise intensity. Therefore, when the measurement information is received, the display of the result input screen ES3 and the input by the user can be omitted.

### [Configuration of the Result Check Screen]

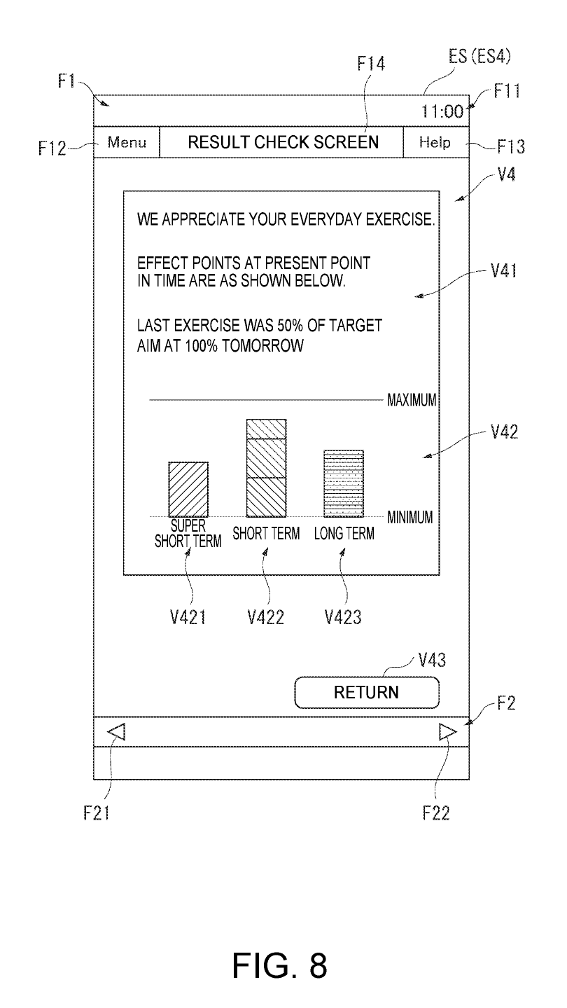

FIG. 8 is a diagram showing an example of the result check screen ES4 among the execution screens ES.

When input operation to the button V34 is performed on the result input screen ES3 or when input operation for displaying the result check screen is performed by the user, the result check screen ES4 shown in FIG. 8 is displayed on the display section 33.

The result check screen ES4 is a screen for presenting an effect by exercise at a stage when the input operation is performed. Like the condition setting screen ES1, such a result check screen ES4 includes the fixed display regions F1 and F2 and a variable display region V4 sandwiched between the fixed display regions F1 and F2.

The variable display region V4 includes an evaluation display region V41, an effect presentation region V42 similar to the predicted-effect presentation region V23, and a button V43 inscribed as “return”.

The evaluation display region V41 is a region where an evaluation for the last exercise is presented by a message. In the example of the result check screen ES4 shown in FIG. 8, in the evaluation display region V41, a message to the effect that an achievement degree of the last exercise is 50% with respect to presented exercise (a target exercise) is set. The achievement degree is an achievement degree input to the achievement-degree input region V313 or an achievement degree calculated on the basis of measurement information received from the measuring apparatus 2.

When the button V43 is input, the result check screen ES4 returns to a screen displayed before the transition to the result check screen ES4.

Like the predicted-effect presentation region V23, the effect presentation region V42 is a region where effect information indicating effects generated by implementation of the exercise is presented. Specifically, the effect presentation region V42 is a region where effect information indicating a plurality of effects respectivelyhaving different durations among the effects is presented. Specifically, the effect presentation region V42 includes a super-short-term-effect presentation region V421, a short-term-effect presentation region V422, and a long-term-effect presentation region V423. Residual times of durations of a super short term effect and a short term effect and the durations and a degree of accumulation of a long term effect are presented. Among these regions, the super-short-term-effect presentation region V421 and the short-term-effect presentation region V422 are regions where, after the user implements exercise on the basis of presented exercise information, a residual time of duration of an effect by implementation of the exercise or duration of the effect is presented.

The super-short-term-effect presentation region V421 is a region where a residual time of duration of the super short effect by the last exercise is indicated by a bar graph. In this case, as explained above, since the duration of the super short term effect is several hours to one day. Therefore, in this embodiment, the duration of the super short term effect is set to 24 hours. In the super-short-term-effect presentation region V421, a bar graph indicating the remaining duration (a residual time) of the short-term effect corresponding to an elapsed time from the last exercise start time is set. Therefore, when 24 hours elapse from the last exercise start time, the residual time decreases to 0 and the bar graph is not displayed. Note that a horizontal line indicating 24 hours, which are a maximum, is set in the super-short-term-effect presentation region V421. Consequently, the duration of the super short term effect is shown.

The short-term-effect presentation region V422 is a region where a residual time of the duration of the short term effect by the last exercise is indicated by a bar graph configured by stacking the blocks. In this case, as explained above, the duration of the short term effect is approximately three days. Therefore, in this embodiment, the duration of the short term effect is set to 72 hours. In the short-term-effect presentation region V422, a bar graph indicating the remaining duration (a residual time) of the short term effect corresponding to an elapsed time from the last exercise start time is set. Therefore, when 24 hours elapse from the last exercise start time, one block is consumed. When 72 hours elapse, the residual time decreases to 0, all the blocks disappear, and the bar graph is not displayed. On the other hand, when the presented exercise is implemented, a bar graph in a state in which three blocks, that is, blocks for 72 hours (for three days) are stacked is displayed. Note that a horizontal line indicating 72 hours, which are a maximum, is set in the short-term-effect presentation region V422. Consequently, the duration of the short term effect is shown.

The durations of the super short term effect and the short term effect respectively obtained by the implementation of the exercise are set according to exercise intensity (specifically, average exercise intensity), an exercise time, and an achievement degree of exercise actually implemented by the user.

Specifically, when the user has been able to implement the presented exercise (when the achievement degree is 100%), as explained above, 24 hours are added as the duration of the short term effect and 72 hours are added as the duration of the short term effect to the durations of the effects at the present point in time. The same applies when the exercise intensity of the implemented exercise is higher than the exercise intensity of the presented exercise.

On the other hand, when the implemented exercise is weaker than the presented exercise, results obtained by multiplying the durations of the super short term effect and the short term effect with coefficients corresponding to the exercise intensity, the exercise time, and the achievement degree of the implemented exercise are added to the durations at the present point in time of the effects as durations of the effects obtained by the implementation of the exercise. These coefficients can be set by various calculation methods. However, in this embodiment, the coefficients are set on the basis of a ratio of the implemented exercise to the presented exercise (i.e., the achievement degree).

For example, when the exercise time is the same in the implemented exercise and the presented exercise but the exercise intensity of the implemented exercise is 60% of the exercise intensity of the presented exercise (when the achievement degree is 60%), results obtained by multiplying 24 hours, which are the duration of the super short term effect, and 72 hours, which are the duration of the short term effect, respectively with 0.6 are added to the durations of the effects at the present point in time as the durations of the super short term effect and the short term effect obtained by the implemented exercise. Therefore, 14.4 hours are added to the duration of the super short term effect at the present point in time and 43.2 hours are added to the duration of the short term effect.

For example, when the exercise intensity is the same in the implemented exercise and the presented exercise but the exercise time of the implemented exercise is 50% of the exercise time of the presented exercise (when the achievement degree is 50%), 12 hours, which are a result obtained by multiplying the duration of the super short term effect with 0.5, are added to the duration of the super short term effect at the present point in time and 36 hours, which are a result obtained by multiplying the duration of the short term effect with 0.5, are added to the duration of the short term effect at the present point in time.

Similarly, when the achievement degree of the implemented exercise is 80%, results obtained by respectively multiplying the durations of the super short term effect and the short term effect with 0.8 are added to the durations of the effects at the present point in time as the durations of the super short term effect and the short term effect obtained by the exercise.

From results obtained by adding the durations to the durations of the effects at the present point in time, a residual time corresponding to an elapsed time from the last exercise start time is calculated. The residual time is shown in the super-short-term-effect presentation region V421 and the short-term-effect presentation region V422.

Note that the exercise intensity and the exercise time of the actual implemented exercise by the user and the achievement degree based on the exercise intensity and the exercise time are acquired on the basis of measurement information acquired from the measuring apparatus 2. Therefore, if the measurement information can be acquired from the measuring apparatus 2, it is possible to indicate more accurate duration.

On the other hand, when the measurement information cannot be acquired, the durations of the effects added to the durations at the present point in time are calculated on the basis of information input on the result input screen ES3.

However, not only this, but, if the user implements exercise, 24 hours, which are the duration of the super short term effect, and 72 hours, which are the duration of the short term effect, may be added to the durations of the effects at the present point in time.

The long-term-effect presentation region V423 is a region where the number of exercise implementation days in thirty days in the past is indicated by a bar graph configured by stacking one block equivalent to one day. Therefore, blocks stacked in a certain day are consumed when thirty days elapse from the stacking of the blocks. When thirty days elapse from the last exercise start time, all the blocks disappear and the bar graph is not displayed. On the other hand, when the presented exercise is implemented, one block is stacked in addition to the present number of blocks. However, in the next day, a bar graph corresponding to the number of exercise implementation days in thirty days in the past is obtained. That is, as in the long-term-effect prediction region V233, the bar graph shown in the long-term-effect presentation region V423 indicates a cumulative value of the long term effect in thirty days, which is a predetermined period. Note that a horizontal line indicating the predetermined period is set in the long-term-effect presentation region V423. Consequently, a calculation period of the long term effect is shown.

Since such a result check screen ES4 is displayed, it is possible to grasp the respective durations of the super short term effect and the short term effect. Besides, since an accumulation state of the long term effect can be grasped, it is possible to improve motivation of the user for exercise.

### [Configuration of the Application Executing Section]

Referring back to FIG. 4, the application executing section 37B executes, among the applications stored in the storing section 35, an application instructed by the OS executing section 37A according to operation information input from the operation section 31. Such an application executing section 37B includes, as functional sections realized by executing the exercise supporting application stored in the storing section 35, an information acquiring section 375, an exercise setting section 376, an exercise-type extracting section 377, and a presentation-information generating section 378.

The information acquiring section 375 acquires the exercise setting conditions set on the condition setting screen ES1 and causes the storing section 35 to store the exercise setting conditions. That is, the information acquiring section 375 is a purpose acquiring section that acquires the purpose of exercise of the user set on the condition setting screen ES1. The information acquiring section 375 is also a parameter acquiring section that acquires presence or absence of exercise habits, a physical condition, and preference of exercise. Further, the information acquiring section 375 is also an elapsed-time acquiring section that acquires an elapsed time from a most recent meal.

The information acquiring section 375 acquires information concerning the exercise result input on the result input screen ES3 and causes the storing section 35 to store the information as well.

Further, the information acquiring section 375 acquires the measurement information received from the measuring apparatus 2 by the communication section 32 under the control by the communication control section 371 and causes the storing section 35 to store the measurement information.

The exercise setting section 376 sets, on the basis of the exercise setting conditions acquired by the information acquiring section 375, target exercise intensity and a target exercise time presented to the user on the exercise presentation screen ES2. In this embodiment, the exercise setting section 376 acquires exercise intensity matching the exercise setting conditions from an exercise intensity table shown in Table 1 below and sets the acquired exercise intensity as the target exercise intensity. Note that contents of the exercise intensity table shown in Table 1 are stored in the storing section 35 in advance as explained above. The exercise setting section 376 acquires relevant exercise intensity referring to the exercise intensity table. However, not only this, but the exercise setting section 376 may calculate the target exercise intensity according to a predetermined calculation formula or may calculate the target exercise intensity according to a flowchart or the like.

Note that, in this embodiment, the exercise setting section 376 sets an exercise time serving as a target (the target exercise time) to thirty minutes. However, not only this, but the target exercise time can be changed as appropriate. The target exercise time may be changed according to the purpose of exercise and the parameters. For example, when the purpose of exercise is the “high blood sugar elimination”, the target exercise time may be set to 20 minutes. When the purpose of exercise is the “obesity elimination”, the target exercise time may be set to 30 minutes.

TABLE 1

| | | | | Exercise |
|---|---|---|---|---|
| | Exercise | Physical | Preference | intensity |
| Purpose | habits | condition | of exercise | (% HRR) |
| Obesity | Yes | Good | Rather intense | 40 to 50 |
| elimination | | | Normal | 35 to 45 |
| | | | Rather weak | 25 to 35 |
| | | Bad | Rather intense | 25 to 30 |
| | | | Normal | |
| | | | Rather weak | |
| | No | Good | Rather intense | 35 to 45 |
| | | | Normal | 30 to 40 |
| | | | Rather weak | 25 to 30 |
| | | Bad | Rather intense | 25 to 30 |
| | | | Normal | |
| | | | Rather weak | |
| High blood | Yes | Good | Rather intense | 60 to 70 |
| sugar | | | Normal | 55 to 65 |
| elimination | | | Rather weak | 45 to 55 |
| | | Bad | Rather intense | 40 to 50 |
| | | | Normal | |
| | | | Rather weak | |
| | No | Good | Rather intense | 55 to 65 |
| | | | Normal | 50 to 60 |
| | | | Rather weak | 40 to 50 |
| | | Bad | Rather intense | 40 to 50 |
| | | | Normal | |
| | | | Rather weak | |

Further, the exercise setting section 376 sets the target exercise intensity on the basis of the exercise setting conditions. However, not only this, but the exercise setting section 376 may adjust the target exercise intensity taking into account the other parameters. For example, the exercise setting section 376 may cause the user to input the weight, a body fat ratio, and a BMI (Body Mass Index) of the user and adjust the target exercise intensity taking into account at least any one of the weight, the body fat ratio, and the BMI.

As shown in Table 1, in this embodiment, when the purpose of exercise is the “high blood sugar elimination” and exercise habits are present, the target exercise intensity is set to 40 to 70% HRR and, when exercise habits are absent, the target exercise intensity is set to 40 to 65% HRR. When the purpose of exercise is the “obesity elimination” and exercise habits are present, the target exercise intensity is set to 25 to 50% HRR and, when exercise habits are absent, the target exercise intensity is set to 25 to 45% HRR. However, ranges of the target exercise intensity corresponding to the respective purposes and the respective parameters can be changed as appropriate. However, when the target exercise intensity is 20% HRR, since the target exercise intensity is equivalent to walking, a load of exercise is low. When the target exercise intensity is 70% HRR, a load of exercise is too high and it is difficult to continuously implement the exercise for a predetermined time (e.g., thirty minutes). Therefore, the ranges of the target exercise intensity for the purposes are desirably set in the ranges explained above.

The exercise-type extracting section 377 extracts an exercise type corresponding to the target exercise intensity set by the exercise setting section 376. Specifically, the exercise-type extracting section 377 extracts an exercise type corresponding to the target exercise intensity referring to the type table stored in the storing section 35. In this case, when there are a plurality of relevant exercise types, the exercise-type extracting section 377 acquires all the relevant exercise types.

The presentation-information generating section 378 generates presentation information presented in the variable display region V2 of the exercise presentation screen ES2 and the variable display region V4 of the result check screen ES4.

Specifically, the presentation-information generating section 378 generates, as the presentation information presented on the exercise presentation screen ES2 (see FIG. 6), information set in the setting-condition display region V21 on the basis of the exercise setting conditions acquired by the information acquiring section 375. The presentation-information generating section 378 generates exercise presentation information set in the exercise presentation region V22, that is, exercise presentation information including the target exercise intensity and the target exercise time set by the exercise setting section 376 and the exercise type extracted by the exercise-type extracting section 377.

A blood sugar level rises according to intake of a meal. Therefore, it is conceivable that post prandial hyperglycemia can be reduced (suppressed) by implementing high-load exercise immediately after the meal. However, it is known that, if the high-load exercise is implemented immediately after the meal, the user tends to become ill because of, for example, inhibition of digestion. Therefore, when the elapsed time (the elapsed time from the most recent meal) input to the elapsed-time setting region V15 of the condition setting screen ES1 is less than thirty minutes, the presentation-information generating section 378 includes a message “Please start exercise after thirty minutes elapse from the meal” in the exercise presentation information.

In diabetics and preliminary diabetics, it is likely that hypoglycemmia is caused by exercise if the elapsed time from the last meal is relatively long. Therefore, when the elapsed time is equal to or longer than a predetermined time (e.g., five hours), the presentation-information generating section 378 includes a message to that effect in the exercise presentation information. For example, when the elapsed time is six hours exceeding the predetermined time, the presentation-information generating section 378 includes a message “Since six hours has elapsed from the last meal, hypoglycemia due to exercise is likely to occur. Please perform exercise after taking a meal” in the exercise presentation information.

Further, the presentation-information generating section 378 generates the bar graphs of the super short term effect, the short term effect, and the long term effect set in the predicted-effect presentation region V23. The super short term effect and the short term effect are the largest when the presented exercise is implemented once. However, since the bar graph of the long term effect indicates the number of exercise implementation days for thirty days in the past, the presentation-information generating section 378 acquires the number of exercise implementation days for thirty days in the past stored in the storing section 35 and generates a bar graph corresponding to a value obtained by adding 1 to the number of exercise implementation days. Note that a period in which the number of exercise implementation days is counted is not limited to thirty days and can be changed as appropriate.

The exercise presentation screen ES2 including the kinds of information generated by the presentation-information generating section 378 is drawn by the drawing section 36 under the control by the display control section 372. Consequently, the exercise presentation screen ES2 is displayed on the display section 33.

The presentation-information generating section 378 generates, as the presentation information presented on the result check screen ES4 (see FIG. 8), a message presented in the evaluation display region V41. In this case, for example, the presentation-information generating section 378 generates a message indicating evaluation of exercise including an achievement degree of the exercise input by the user on the result input screen ES3 or an achievement result of the exercise based on the measurement information received from the measuring apparatus 2. The presentation-information generating section 378 generates the bar graphs of the super short term effect, the short term effect, and the long term effect by the exercise presented in the effect presentation region V42.

The presentation-information generating section 378 calculates residual times of durations of the super short term effect and the short term effect according to an elapsed time from the last exercise start time (or end time) and generates the bar graphs indicating ratios of the residual times to the durations.

The presentation-information generating section 378 counts the number of exercise implementation days in thirty days in the past and stacks blocks by a number corresponding to the number of exercise implementation days to generate the bar graph indicating a ratio of the number of exercise implementation days to the maximum (thirty days). Note that, as explained above, a period in which the number of exercise implementation days is counted is not limited to thirty days and can be changed as appropriate.

The result check screen ES4 including the kinds of information generated by the presentation-information generating section 378 is drawn by the drawing section 36 under the control by the display control section 372. Consequently, the result check screen ES4 is displayed on the display section 33.

### [Exercise Presentation Processing]

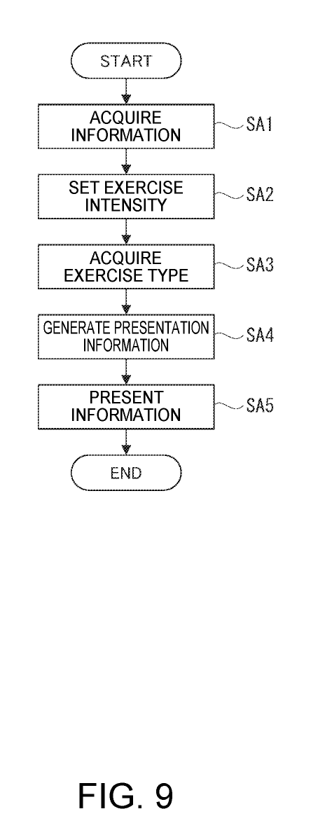

FIG. 9 is a flowchart showing exercise presentation processing executed by the control section 37.

When the button V17 (see FIG. 5) of the condition setting screen ES1 is input, the control section 37 executes the exercise presentation processing according to the exercise presenting program included in the exercise supporting application. The exercise presentation processing is processing for displaying the exercise presentation screen ES2 indicating exercise corresponding to the exercise setting conditions set by the user and presenting the exercise to the user.

In the exercise presentation processing, as shown in FIG. 9, first, the information acquiring section 375 acquires the exercise setting conditions set in the setting regions V11 to V15 of the condition setting screen ES1, that is, the purpose of exercise, the presence or absence of exercise habits, the present physical condition of the user, the preference of exercise of the user, and the elapsed time from the most recent meal (step SA1).

Further, the exercise setting section 376 acquires exercise intensity corresponding to the acquired exercise setting conditions from the exercise intensity table stored in the storing section 35 and sets the exercise intensity as target exercise intensity. Besides, the exercise setting section 376 sets a target exercise time (step SA2).

The exercise-type extracting section 377 extracts an exercise type corresponding to the set target exercise intensity from the type table stored in the storing section 35 (step SA3).

Subsequently, the presentation-information generating section 378 generates presentation information presented on the operation presentation screen ES2 on the basis of the acquired exercise setting conditions, the set target exercise intensity and the set target exercise time, the extracted exercise type, and the exercise result or the measurement information in the past stored in the storing section 35 (step SA4).

Thereafter, the display control section 372 causes the drawing section 36 to draw the exercise presentation screen ES2 including the generated presentation information and causes the display section 33 to display the exercise presentation screen ES2 (step SA5). Consequently, the presentation information is presented.

The exercise presentation processing is ended by the processing in step SA5.

### [Result Presentation Processing]

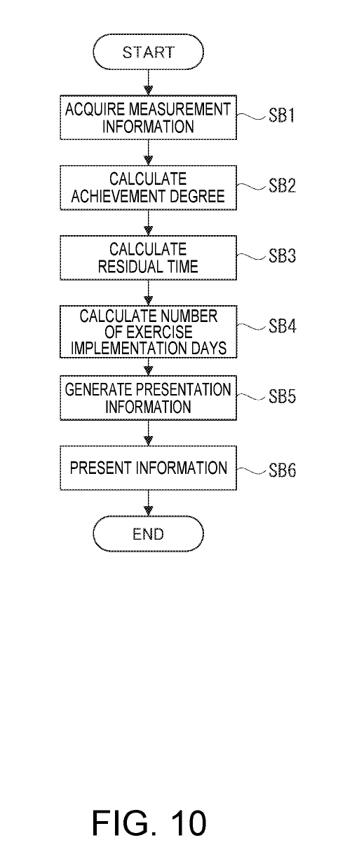

FIG. 10 is a flowchart showing the result presentation processing executed by the control section 37.

When the button V34 (see FIG. 7) of the result input screen ES3 is input or when input operation for displaying the result check screen ES4 is performed by the user, the control section 37 executes the result presentation processing according to the result presenting program included in the exercise supporting application. The result presentation processing is processing for displaying the result check screen ES4 and presenting an effect by exercise to the user.

In the result presentation processing, as shown in FIG. 10, first, the presentation-information generating section 378 acquires measurement information received from the measuring apparatus 2 and stored in the storing section 35 (step SB1).

Thereafter, the presentation-information generating section 378 calculates, on the basis of the acquired measurement information, average exercise intensity and an average exercise time of actually performed exercise and calculates, on the basis of the average exercise intensity and the average exercise time, an achievement degree with respect to target exercise intensity and target exercise time presented last time (step SB2).

The presentation-information generating section 378 specifies the last exercise start time (or exercise end time) on the basis of the measurement information and calculates, according to an elapsed time from the time, residual times of durations of the super short term effect and the short term effect (step SB3).

Further, the presentation-information generating section 378 calculates (counts) the number of exercise implementation days in thirty days in the past on the basis of the measurement information and the like (step SB4).

The presentation-information generating section 378 generates presentation information presented on the result check screen ES4 on the basis of the achievement degree of the exercise, the residual times of the durations of the super short term effect and the short term effect, and the number of exercise implementation days in thirty days in the past calculated in steps SB2 to SB4 (step SB5).

Thereafter, the display control section 372 causes the drawing section 36 to draw the result check screen ES4 including the generated presentation information and causes the display section 33 to display the result check screen ES4 (step SB6). Consequently, the presentation information is presented and action statuses of the super short term effect, the short term effect, and the long term effect are presented.

The result presentation processing is ended by the processing in step SB6.

Note that, in the effect presentation processing, the result check screen ES4 is displayed on the basis of the measurement information indicating the measurement result by the measuring apparatus 2. However, as explained above, when the measuring apparatus 2 is absent or when the measurement information cannot be received, it is also possible to display the result check screen ES4 based on input information to the result input screen ES3. In this case, in step SB1, input information of the user to the result input screen ES3 displayed last time only has to be acquired. In steps SB2 to SB4, the acquisition of the achievement degree, the calculation of the residual times, and the calculation of the number of exercise implementation days only have to be performed on the basis of input information in the past. Further, the information displayed on the basis of the measurement information indicating the measurement result by the measuring apparatus 2 may be configured to be correctable by the user. For example, the display control section 372 may cause the drawing section 36 and the display section 33 to draw and display a correction screen on which the measurement information can be corrected. The information acquiring section 375 may update the measurement information stored in the storing section 35 on the basis of contents input on the correction screen.

### [Effects of the Embodiment]

With the exercise supporting system 1 according to this embodiment explained above, there are effects explained below.

A purpose of exercise input by the user on the condition setting screen ES1 is acquired by the information acquiring section 375. Target exercise intensity and a target exercise time corresponding to the purpose of exercise are set by the exercise setting section 376. An exercise type corresponding to the target exercise intensity is extracted from the type table by the exercise-type extracting section 377. Presentation information including the target exercise intensity, the target exercise time, and the exercise type is generated by the presentation-information generating section 378 and the exercise presentation screen ES2 including the presentation information is displayed. Consequently, it is possible to present effective exercise corresponding to the purpose of exercise of the user to the user. In particular, since the exercise type corresponding to the set exercise intensity is displayed, it is possible to make it easy for the user to grasp exercise that the user should implement.

The information acquiring section 375 acquires, besides the purpose of exercise input on the condition setting screen ES1, three personal parameters of presence or absence of exercise habits of the user, a present physical condition of the user, and preference (an intensity level) of exercise of the user. The exercise setting section 376 sets exercise intensity and an exercise time based on the three personal parameters besides the acquired purpose of exercise. Consequently, it is possible to present exercise suitable for the present situation of the user. Therefore, it is possible to present more effective exercise to the user.

On the condition setting screen ES1, high blood sugar elimination after a meal and obesity elimination are illustrated as the purpose of exercise of the user and selection items corresponding to the high blood sugar elimination and the obesity elimination are set. Consequently, as in the exercise intensity table, it is possible to retain exercise intensity corresponding to a purpose to be selected. Therefore, it is possible to set, as exercise for the purpose of the high blood sugar elimination after a meal, exercise having high exercise intensity compared with exercise for the purpose of the obesity elimination. It is possible to surely present exercise having exercise intensity corresponding to the purpose.

The user can input the purpose of exercise by selecting the purpose of exercise from the selection items. Therefore, the user can input the purpose of exercise without being confused.

On the exercise presentation screen ES2, information (the exercise intensity, the exercise type, and the exercise time) concerning exercise that the information processing apparatus 3 causes the user to implement is presented in the exercise presentation region V22. Besides, bar graphs indicating the effects (the super short term effect, the short term effect, and the long term effect) by the implementation of the exercise are presented in the predicted-effect presentation region V23. Consequently, it is possible to visually grasp the effects of the implementation of the exercise. Therefore, it is possible to improve motivation of the user for the implementation of the presented exercise.

On the exercise presentation screen ES2, bar graphs indicating residual times of durations of the super short term effect and the short term effect, the residual time being increased by exercise, and a bar graph indicating an action status of the long term effect and indicating a cumulative value of the number of exercise implementation days in thirty days in the past are shown in the predicted-effect presentation region V23. Consequently, it is possible to grasp the respective effects by the exercise. Therefore, it is possible to further improve the motivation of the user.

It is possible to grasp how long the super short term effect and the short term effect continue and to which degree the long term effect is accumulated by performing the presented exercise once. Therefore, in this regard as well, it is possible to further improve the motivation of the user.

On the result check screen ES4, residual times of respective durations of the super short term effect and the short term effect after exercise is implemented last time are presented. Consequently, as time elapses after the exercise is implemented last time, the residual times of the durations of the effects decrease. Unless exercise is performed, the residual times decrease to 0. Therefore, since it is possible to grasp that the effects by the exercise implemented last time decrease, it is possible to further improve the motivation of the user.

### [Modifications of the Embodiment]

The present invention is not limited to the embodiment. Modifications, improvements, and the like in a range in which the object of the present invention can be achieved are included in the present invention.

In the embodiment, the exercise supporting system 1 includes the measuring apparatus 2 and the information processing apparatus 3. However, the present invention is not limited to this. That is, as explained above, the exercise presenting apparatus of the present invention can be configured by the information processing apparatus 3 alone. In the embodiment, the pulse rate meter is illustrated as the measuring apparatus 2. However, the present invention is not limited to this. That is, the measuring apparatus 2 only has to be capable of transmitting information indicating an exercise state of the user to the information processing apparatus 3. For example, the measuring apparatus 2 may be an activity meter that calculates the number of steps, a total consumed calorie, and the like of the user.

In the embodiment, the “high blood sugar elimination after a meal” and the “obesity elimination” are illustrated as the selection items of the purpose of exercise. However, the present invention is not limited to this. That is, the purpose of exercise input by the user may be other contents such as fat burning, health promotion, physical strength improvement, and physical constitution improvement.

If the information processing apparatus 3 causes the user to periodically input body information such as weight and a body fat ratio and determines on the basis of the body information that obesity is eliminated, the selection item “obesity elimination” may be changed to the selection item such as “health promotion”.

In the embodiment, the storing section 35 has stored therein the exercise intensity table in which the range of exercise intensity corresponding to the purpose of exercise, the presence or absence of exercise habits of the user, the present physical condition of the user, and the preference of exercise of the user is set. The exercise setting section 376 acquires, from the exercise table, exercise intensity corresponding to information input on the condition setting screen ES1 and sets the exercise intensity as the target exercise intensity. However, the present invention is not limited to this. For example, as explained above, the exercise intensity maybe calculated by a predetermined formula or may be calculated by a flowchart or the like.

In the embodiment, on the condition setting screen ES1, the information processing apparatus 3 causes the user to input the three personal parameters of the presence or absence of exercise habits of the user, the present physical condition of the user, and the preference of exercise (the intensity level of preferred exercise) besides the purpose of exercise. The exercise setting section 37 sets exercise intensity corresponding to the personal parameters. However, the present invention is not limited to this. That is, target exercise intensity presented to the user may be set according to only the purpose of exercise or the target exercise intensity. The target exercise intensity may be set on the basis of one or two of the three personal parameters. Besides, the information processing apparatus 3 may be configured to cause the user to input other personal parameters instead of at least one of the three personal parameters or in addition to the three personal parameters. For example, the information processing apparatus 3 may cause the user to input time when exercise can be implemented. The exercise setting section may set exercise intensity corresponding to the time.

In the embodiment, the exercise presentation region V22 in which the set exercise intensity, the set exercise time, and the set exercise type are set and the predicted-exercise presentation region V23 indicating an effect at the time when the presented exercise is implemented by the user are included in the exercise presentation screen ES2. However, the present invention is not limited to this. That is, the predicted-effect presentation region V23 may be absent. A method of display of the super short term effect, the short term effect, and the long term effect shown in the predicted-effect presentation region V23 can be changed as appropriate. For example, the durations of the super short term effect and the short term effect and the number of exercise implementation days may be indicated by other graphs, which are not the bar graphs, or may be indicated by numerical values and sentences. The same applies to the result check screen ES4. Further, the effects shown in the predicted-effect presentation region V23 may be other effects such as decreases in a blood sugar level and weight. At least any one of the super short term effect, the short term effect, and the long term effect may be absent. The same applies to the effect presentation region V42.

In the embodiment, contents of exercise presented to the user are presented by being included in the exercise presentation screen ES2 displayed on the display section 33. However, the present invention is not limited to this. That is, the contents of the exercise to be presented may be presented to the user by causing the sound output section 34 to output the contents by sound instead of the display on the exercise presentation screen ES2 or in addition to the display on the exercise presentation screen ES2.

Information concerning the exercise presented by the display section 33 and the sound output section 34 is not limited to the exercise intensity, the exercise type, and the exercise time and may include other information. On the other hand, the presentation information only has to include at least any one of the exercise intensity, the exercise type, and the exercise time. For example, the presentation information may include only the exercise intensity or the exercise type or may include the exercise time in addition to the exercise intensity or the exercise type.

In the embodiment, on the condition setting screen ES1, the radio buttons are respectively disposed in the setting regions V11 to V14 to cause the user to select the items. However, the present invention is not limited to this. For example, the condition setting screen ES1 may be configured to cause the user to select the items with a slide bar or may be configured to cause the user to input the items as characters.

In the embodiment, the display section 33 displays the condition setting screen ES1, the exercise presentation screen ES2, the result input screen ES3, and the result check screen ES4 shown in FIG. 5 to FIG. 8. However, the present invention is not limited to this. That is, a layout of the screens can be changed as appropriate.

In the embodiment, the exercise presenting program is included in the exercise supporting application. However, the present invention is not limited to this. That is, the exercise presenting program for causing the control section 37 to execute the exercise presentation processing and the result presenting program for causing the control section 37 to execute the result presentation processing may be respectively independently executed.

In the embodiment, the exercise presenting program and the result presenting program are stored in the storing section 35. However, the present invention is not limited to this. For example, the exercise presenting program and the result presenting program may be stored in a server on a network, a disk-type recording medium, an external semiconductor memory, and the like and, when the operation presenting program or the result presenting program is executed, the exercise presenting program or the result presenting program may be acquired from the server, the disk-type recording medium, the external semiconductor memory, and the like and executed. The same applies to the exercise supporting application. That is, a storage form and a presentation form of each of the exercise presenting program and the result presenting program and the exercise supporting application including the exercise presenting program and the result presenting program may be any form as long as the programs can be used by a computer such as the information processing apparatus 3.

In the embodiment, the effects of the exercise are classified into the super short term effect, the short term effect, and the long term effect from the viewpoint of the effective durations of the effects. In the predicted-effect presentation region V23 and the effect presentation region V42, residual times of respective durations of the super short term effect and the short term effect or the durations and a degree of accumulation of the long term effect are displayed. However, the present invention is not limited to this. That is, the effects of the exercise may be classified according to the respective characteristics of the effects and displayed. For example, the super short term effect, the short term effect, and the long term effect may be displayed in names indicating characteristic effects in the effects respectively classified into the super short term effect, the short term effect, and the long term effect such as an energy supplying function, a blood sugar level increase suppressing function, and a visceral fat burning function rather than displaying the super short term effect, the short term effect, and the long term effect in names of the respective effects. Consequently, it is possible to make it easy to more intuitively grasp effects of exercise. Note that names of the effects to be displayed are not limited to these names and may be other names. The effects may be classified from other viewpoints. That is, effects generated by implementation of exercise only have to be presented in the predicted-effect presentation region V23 and the effect presentation region V42. Among the effects, a plurality of effects respectively having different durations may be more desirably presented to the user.

In the embodiment, the information processing apparatus 3 causes the user to input the elapsed time from the most recent meal in the elapsed-time setting region V15 on the condition setting screen ES1. The information acquiring section 375 acquires input contents to the elapsed-time setting region V15. However, the present invention is not limited to this. For example, when the user sequentially inputs detailed information of meals on a meal input screen displayed by the display control section 372, the elapsed time from the most recent meal may be acquired from input contents to the meal input screen. Further, when the measuring apparatus 2 is configured to record timing (time) of a meal according to predetermined operation (a button input or tap operation) to the measuring apparatus 2, the information acquiring section 375 may be configured to acquire time of the most recent meal from the measuring apparatus 2 and acquire the elapsed time on the basis of the acquired time of the most recent meal and the present time clocked by the clocking section 374.

### REFERENCE SIGNS LIST

3 information processing apparatus (exercise presenting apparatus)

33 display section (presenting section)

34 sound output section (presenting section)

375 information acquiring section (purpose acquiring section, parameter acquiring section)

376 exercise setting section

378 presentation-information generating section

1. An exercise presenting apparatus comprising:
a purpose acquiring section that acquires an input purpose of exercise;
an exercise setting section that sets exercise intensity and an exercise time corresponding to the acquire purpose; and
a presentation-information generating section that generates presentation information including at least one of the set exercise intensity and an exercise type corresponding to the exercise intensity and the exercise time.

2. The exercise presenting apparatus according to claim 1, further comprising a parameter acquiring section that acquires input personal parameters of at least any one of presence or absence of exercise habits of a user, a physical condition of the user, and exercise preferred by the user, wherein
the exercise setting section sets the exercise intensity and the exercise time corresponding to the purpose and the personal parameters.

3. The exercise presenting apparatus according to claim 1, wherein the purpose is selected from selection items including high blood sugar elimination and obesity elimination and input.

4. The exercise presenting apparatus according to claim 1, wherein the presentation-information generating section generates the presentation information including effect information indicating an effect by implementation of exercise indicated by the set exercise intensity and the set exercise time.

5. The exercise presenting apparatus according to claim 4, wherein the effect information indicates at least one of duration of the effect classified for each of types of the effect information and a cumulative value of the effect in a predetermined period.

6. The exercise presenting apparatus according to claim 1, wherein, after exercise indicated by the set exercise intensity and the set exercise time is implemented, the presenting section presents a residual time of duration of an effect by implementation of the exercise.

7. An exercise presenting system comprising:
a purpose acquiring section that acquires purpose information representing a purpose of exercise implemented by a user;
a parameter acquiring section that acquires personal parameters including at least any one of presence or absence of exercise habits of the user, a physical condition of the user, and exercise preferred by the user;
an exercise setting section that sets exercise intensity or an exercise type of the exercise implemented by the user and an exercise time on the basis of the purpose information and the personal parameters;
a presentation-information generating section that generates effect information representing an effect obtained when the exercise set by the exercise setting section is implemented; and
a display section that displays the effect information.

8. The exercise presenting system according to claim 7, further comprising an information terminal including the purpose acquiring section, the parameter acquiring section, and the display section.

9. The exercise presenting system according to claim 7, further comprising a server including the purpose acquiring section, the parameter acquiring section, and the presentation-information generating section.

10. The exercise presenting system according to claim 7, wherein the purpose information is selected from selection items including high blood sugar elimination and obesity elimination and input.

11. The exercise presenting system according to claim 7, wherein the effect information includes a plurality of exercise effect types having different durations of the effect obtained by the implementation of the exercise.

12. The exercise presenting system according to claim 11, wherein the display section shows at least one of the duration corresponding to at least one of the plurality of exercise effect types and cumulative information of the effect.

13. The exercise presenting apparatus according to claim 2, wherein the purpose is selected from selection items including high blood sugar elimination and obesity elimination and input.

14. The exercise presenting apparatus according to claim 2, wherein the presentation-information generating section generates the presentation information including effect information indicating an effect by implementation of exercise indicated by the set exercise intensity and the set exercise time.

15. The exercise presenting apparatus according to claim 14, wherein the effect information indicates at least one of duration of the effect classified for each of types of the effect information and a cumulative value of the effect in a predetermined period.

16. The exercise presenting apparatus according to claim 3, wherein the presentation-information generating section generates the presentation information including effect information indicating an effect by implementation of exercise indicated by the set exercise intensity and the set exercise time.

17. The exercise presenting apparatus according to claim 16, wherein the effect information indicates at least one of duration of the effect classified for each of types of the effect information and a cumulative value of the effect in a predetermined period.

18. The exercise presenting apparatus according to claim 2, wherein, after exercise indicated by the set exercise intensity and the set exercise time is implemented, the presenting section presents a residual time of duration of an effect by implementation of the exercise.

19. The exercise presenting apparatus according to claim 3, wherein, after exercise indicated by the set exercise intensity and the set exercise time is implemented, the presenting section presents a residual time of duration of an effect by implementation of the exercise.

20. The exercise presenting apparatus according to claim 4, wherein, after exercise indicated by the set exercise intensity and the set exercise time is implemented, the presenting section presents a residual time of duration of an effect by implementation of the exercise.
